(19) United States
(12) Patent Application Publication
(10) Pub. No.: US 2009/0083422 A1
(43) Pub. Date: Mar. 26, 2009

(54) Apparatus and method for improving network infrastructure

(75) Inventors: Jeffrey A. McKay, Gaithersburg, MD (US); Christopher A. Smith, Falling Waters, WV (US)

Correspondence Address: THE NATH LAW GROUP, 112 South West Street, Alexandria, VA, 22314, US

(73) Assignee: NETWORK CONNECTIVITY SOLUTIONS CORP., Hagerstown, MD (US)

(21) Appl. No.: 12/232,761

(22) Filed: Sep. 24, 2008

Related U.S. Application Data
(60) Provisional application No. 60/960,316, filed on Sep. 25, 2007.

(51) Int. Cl. G06F 15/16

(52) U.S. Cl. 709/225; 709/238

(57) ABSTRACT

An apparatus for improving network infrastructure includes multiple network components. The network components include a Firewall and a Domain Name Service server. The network components may also include a Network Attached Storage device, an On-Demand Ad Hoc Network service provider, a Local Load Balancer, a Global Load Balancer, a Multi-Protocol Reverse Proxy, a Forward Proxy, a Secure Socket Layer Virtual Private Network Appliance, and/or a Network Optimizer Appliance. The apparatus also includes one or more routers that provide the only external connectivity to the apparatus, and a switch through which some or all of the network components communicate. The apparatus may be made part of a network of like apparatuses, where each router of each of the apparatuses executes electronic instructions for providing an on-demand private network with the other apparatuses. The apparatus may be configured so that the private network complies with guidelines for government, military, or business security.

### CROSS-REFERENCE

This application claims benefit of provisional U.S. Patent Application No. 60/960,316 filed Sep. 25, 2007, the contents of which are hereby incorporated by reference in its entirety.

### BACKGROUND OF THE INVENTION

1. Field of the Invention

The present disclosure relates to improving network infrastructure, and in particular, to apparatuses and methods for providing a physical and logical infrastructure for network components that improve network infrastructure.

2. Related Art

Many industries today require more distributed computing, virtualization, and service-oriented architecture than ever before. As an example, the Department of Defense (DoD) in recent years has begun a major shift to utility computing, and the DoD's Defense Information Systems Agency (like agencies in many other industries) has begun to treat commercial software for distributed computing and virtualization as a utility service. Where distributed computing, virtualization, and service-oriented architecture are used, security can become a major issue, and difficulties can arise in forming and maintaining secure private networks in which commercial software may be run. Moreover, solutions for forming private networks are often deficient in agility, scalability, and management visibility. Meeting these demands can often undesirably lead to higher infrastructure and management costs. Other problems which arise when using distributed computing, virtualization, and service-oriented architecture in a private network are: applications that do not perform well over the wide area; bandwidth-constrained users; difficulty in establishing on-demand community of interest (COI) networks; difficulty in migrating legacy applications to the Web; and difficulty in moving content forward for deployed users.

In networks over which distributed computing, virtualization, and service-oriented architectures are desired, there is a tendency to add individual applications and connectivity solutions without regard to efficiency, security, or compatibility with other products. Transmission Control Protocol (TCP) applications are often designed under optimal environments and ultimately do not perform well in high latency Wide Area Networks (WANs). Bandwidth is often increased to remedy this poor performance, although the round trip delay of the link is often also at fault. Satellite links are notorious for high latency delays. Legacy protocols for high priority applications that are insecure in nature are allowed to transit non-secure boundaries in the clear without any encryption of user data. Secure user connectivity is not consistent across different departmental boundaries or not instituted at all or lacks a consistent security posture. While governmental Information Assurance (IA) directives are written to prevent insecure connectivity between client/server or server/server applications, they do not recommend a secure convention to follow that is easily implemented for a variety of environments.

What is needed is a single apparatus for improving network infrastructure by addressing the above shortcomings.

### SUMMARY OF THE INVENTION

The present subject matter addresses the above concerns by teaching the following methods and apparatuses.

In the following examples, the term “layer” makes reference to the Open System Interconnection (OSI) Reference Model which comprises seven layers named (from layer 1 to layer 7, respectively): Physical, Data Link, Network, Transport, Session, Presentation and Application. However, the present apparatuses and methods may be applied according to any tiered communication system, and in particular those in which each layer assumes an independent function and may be individually modified without destabilizing the entire system protocols According to one aspect of the present disclosure, an apparatus for improving network infrastructure includes multiple network components. The network components include a Firewall and a Domain Name Service (DNS) server. The network components may also include a Network Attached Storage (NAS) device, an On-Demand Ad Hoc Network service provider, a Local Load Balancer, a Global Load Balancer, a Multi-Protocol Reverse Proxy, a Forward Proxy, a Secure Socket Layer Virtual Private Network Appliance, and/or a Network Optimizer Appliance. Other network components may also be used. The apparatus also includes a router or routers that provide the only external connectivity to the apparatus, and a switch through which at least two of the network components communicate. In some optional aspects, all of the network components communicate through the same switch.

In some optional aspects, the switch filters and forwards layer 2 packets, to provide distinct logical separation for a Virtual Local Area Network (VLAN).

In some optional aspects, the Firewall executes electronic instructions for providing protection for internal assets from external entities on at least one layer selected from the group consisting of: layer 3, layer 4, layer 5, layer 6, and layer 7. In some optional aspects, the Firewall executes electronic instructions for enabling secure connections for external management of the network components.

In some optional aspects, at least one of the network components is an On-Demand Ad Hoc Network service provider which executes electronic instructions for dynamically adding users to a network and for enabling said users to securely access applications internal to the network.

In some optional aspects, the apparatus is part of a network of like apparatuses. One of the apparatuses has a Global Load Balancer, while some or all of the other apparatuses has a Local Load Balancer. The Global Load Balancer works in conjunction with the Local Load Balancers and executes electronic instructions for using a DNS to dynamically route a user to content stored at one of the apparatuses from among the apparatuses which is closest to the user.

In some optional aspects, at least one of the network components is a Multi-Protocol Reverse Proxy that reduces access time to network content and prevents direct external access under multiple protocols. The protocols may be File Transfer Protocol (FTP), Lightweight Directory Access Protocol (LDAP), and Secure Shell (SSH). Other protocols may also or alternatively be proxied.

In some optional aspects, at least one of the network components is a Forward Proxy that reduces access time to external hosts and prevents direct output under one or more protocols. The protocols may be HyperText Transfer Protocol (HTTP), HyperText Transfer Protocol Secure (HTTPS), File Transfer Protocol (FTP), Lightweight Directory Access Protocol (LDAP), and Secure Shell (SSH). Other protocols may also or alternatively be proxied.

In some optional aspects, at least one of the network components is an On-Demand Ad Hoc Network service provider that executes electronic instructions for dynamically adding users to a network and for enabling those users to securely access applications internal to the network.

In some optional aspects, the apparatus is part of a network of like apparatuses. In some of these aspects, two of the apparatuses have Network Optimizer Appliances such as TCP Optimizers that improve TCP flow between apparatuses for improving network infrastructure.

In some optional aspects, the apparatus is part of a network of like apparatuses. In some of these aspects, each router of each of the apparatuses executes electronic instructions for providing an on-demand COI with the other apparatuses.

In some optional aspects, the apparatus further comprises a Keyboard Video Mouse (KVM) Appliance which executes electronic instructions for providing configuration access to network components.

In some optional aspects, the apparatus further comprising a Serial Console Appliance that executes electronic instructions for providing configuration access to network components.

In some optional aspects, the apparatus further comprises a Power over IP Appliance configured to power cycle one or more of the network components upon remote instructions.

In some optional aspects, the apparatus includes an auditor for auditing security-related events.

According to another aspect of the present disclosure, a method of improving the infrastructure of a network includes: establishing and maintaining a private network over a WAN; providing Firewall protection for internal assets of the private network from external entities on at least one of layers 3-7; enabling a secure connection for external management of those network components used to establish the private network; and receiving a DNS request from a user of the private network and dynamically routing the user to content corresponding to the request and stored near the user on the private network. In some embodiments, the method is operable from a single apparatus with communicative connection to the WAN. In some embodiments, the method is operable from a plurality of apparatuses distributed across the WAN, with communicative connection to the WAN.

In some optional aspects, the method further includes establishing at least one Virtual LAN and providing logical separation between said Virtual LAN and either of said private network or said WAN by filtering and forwarding layer 2 packets.

In some optional aspects, the method further includes preventing direct external access to said private network under two or more protocols selected from the list consisting of: HyperText Transfer Protocol (HTTP), HyperText Transfer Protocol Secure (HTTPS), File Transfer Protocol (FTP), Lightweight Directory Access Protocol (LDAP), and Secure Shell (SSH); and preventing direct output from said private network under one or more protocols selected from the list consisting of: HyperText Transfer Protocol (HTTP), HyperText Transfer Protocol Secure (HTTPS), File Transfer Protocol (FTP), Lightweight Directory Access Protocol (LDAP), and Secure Shell (SSH).

In some optional aspects, the method further includes dynamically adding users to the private network and enabling these users to securely access applications internal to the private network.

According to another aspect of the present disclosure, an apparatus for improving network infrastructure includes one or more routers that provide the only external connectivity to the apparatus, and a switch. The switch executes electronic instructions for providing a communicative connection among at least two network components selected from the group consisting of: a Firewall, a Network Attached Storage device, an On-Demand Ad Hoc Network service provider, a Local Load Balancer, a Global Load Balancer, a Multi-Protocol Reverse Proxy, a Forward Proxy, a Network Optimizer Appliance, and a DNS server. Other network components may also or alternatively communicate through the switch. The apparatus also includes a housing configured to physically house the network components. In this aspect, the communicative connection complies with one or more information security protocols.

### BRIEF DESCRIPTION OF THE DRAWINGS

The features, nature, and advantages of the presently disclosed methods and apparatuses will become more apparent from the detailed description set forth below when taken in conjunction with the drawings in which like reference characters identify corresponding items throughout.

FIG. 1 illustrates a schematic diagram of one apparatus according to the present disclosure.

FIG. 2 illustrates the distribution of multiple apparatuses across a WAN according to the present disclosure.

FIG. 3 illustrates data flow through a Firewall according to the present disclosure.

FIG. 4 illustrates encryption security for ports and protocols for communication with a Network Attached Storage (NAS) according to the present disclosure.

FIG. 5 illustrates a first step in an example process for forming data flows for an On-Demand Ad Hoc Network service according to the present disclosure.

FIG. 6 illustrates a second step in the process of FIG. 5.

FIG. 7 illustrates a third step in the process of FIG. 5.

FIG. 8 illustrates a fourth step in the process of FIG. 5.

FIG. 9 illustrates a fifth step in the process of FIG. 5.

FIG. 10 illustrates a sixth step in the process of FIG. 5.

FIG. 11 illustrates a first step in an example process of Global Load Balancing by two apparatuses disposed at multiple locations on a network according to the present disclosure.

FIG. 12 illustrates a second step in the process of FIG. 11.

FIG. 13 illustrates a third step in the process of FIG. 11.

FIG. 14 illustrates a fourth step in the process of FIG. 11.

FIG. 15 illustrates a fifth step in the process of FIG. 11.

FIG. 16 illustrates a sixth step in the process of FIG. 11.

FIG. 17 illustrate a first step in an example process of reverse proxying with dynamic resolution by two apparatuses disposed at multiple locations on a network according to the present disclosure.

FIG. 18 illustrates a second step in the process of FIG. 17.

FIG. 19 illustrates a third step in the process of FIG. 17.

FIG. 20 illustrates a fourth step in the process of FIG. 17.

FIG. 21 illustrates a fifth step in the process of FIG. 17.

FIG. 22 illustrates a sixth step in the process of FIG. 17.

FIG. 23 illustrates a first step in an example process of forward proxying with dynamic resolution by two apparatuses disposed at multiple locations on a network according to the present disclosure.

FIG. 24 illustrates a second step in the process of FIG. 23.

FIG. 25 illustrates a third step in the process of FIG. 23.

FIG. 26 illustrates a fourth step in the process of FIG. 23.

FIG. 27 illustrates a fifth step in the process of FIG. 23.

FIG. 28 illustrates a sixth step in the process of FIG. 23.

FIG. 29 illustrates a seventh step in the process of FIG. 23.

FIG. 30 illustrates a eighth step in the process of FIG. 23.

FIG. 31 illustrates a ninth step in the process of FIG. 23.

FIG. 32 illustrates a tenth step in the process of FIG. 23.

FIG. 33 illustrates a first step in an example process of optimized data flow utilizing Network Optimizer Appliances according to the present disclosure.

FIG. 34 illustrates a second step in the process of FIG. 33.

FIG. 35 illustrates a third step in the process of FIG. 33.

FIG. 36 illustrates a fourth step in the process of FIG. 33.

FIG. 37 illustrates a fifth step in the process of FIG. 33.

FIG. 38 illustrates a sixth step in the process of FIG. 33.

### DETAILED DESCRIPTION

The present disclosure includes apparatuses for improving network infrastructure. The apparatus provides a physical and logical infrastructure to house individually selected network components. When two or more apparatuses are deployed across a larger WAN, the apparatuses can collectively form secure private networks, Virtual Private Networks (VPNs) and On-Demand COIs. Throughout this specification, the apparatus will also be referred to as a “base” or a “node,” while the apparatus and/or the method of forming a private network using a plurality of such apparatuses may be labeled with the trademarked term “PS4.” The apparatus allows secure transport of specific application ports and protocols to and from the apparatus, and also supports secure transport of specific application ports and protocols between the network components housed therein.

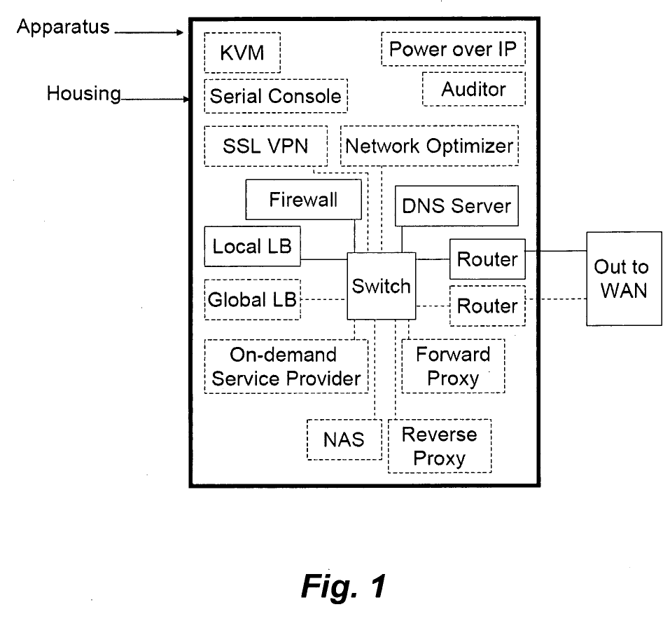

FIG. 1 illustrates a schematic diagram of one apparatus according to the present disclosure. Each element in the figure is discussed below. Optional components are shown in dashed lines.

The apparatus, or “node,” includes one or more routers. The router or routers are expected to provide the only external network connectivity to the apparatus, thereby increasing the security of the apparatus. A node is thus configured to be connected to a WAN through the router or routers, to create a single threaded flow of network components, optionally with built-in redundancies. Routing with the WAN need not be limited by any specific type of routing protocol, and may involve External Border Gateway Protocol (eBGP) as well as static routing.

One may deploy a single node according to the present disclosure at the juncture of a LAN and a WAN, to provide security for the LAN in an efficient, integrated manner. However, in many aspects, it is advantageous to deploy a plurality of like nodes across a network. The router may thus provide Dynamic Multipoint Virtual Private Network (DMVPN) capabilities, to provide On-Demand COIs across the WAN among a plurality of such apparatuses. Optionally, the router may provide the first step in a Defense-in-Depth posture by providing access-list blocking of well-known bad ports, protocols and IP addresses. The router may also provide a Boundary defined within a Ports, Protocols, and Services Assurance Category Assignments Lists (PPS CAL). Routing protocols may be run between the WAN and the apparatus, or routing may be static. If routing is to be configured, the external Border Gateway Protocol may be used. The term “external” will be used throughout this disclosure to refer to communication or apparatuses located on the WAN but on the public side of a node, while the term “private” will be used to refer to communication or apparatuses located on a private, secure side of a node or nodes. Thus, a plurality of like nodes deployed across a WAN can form a private network.

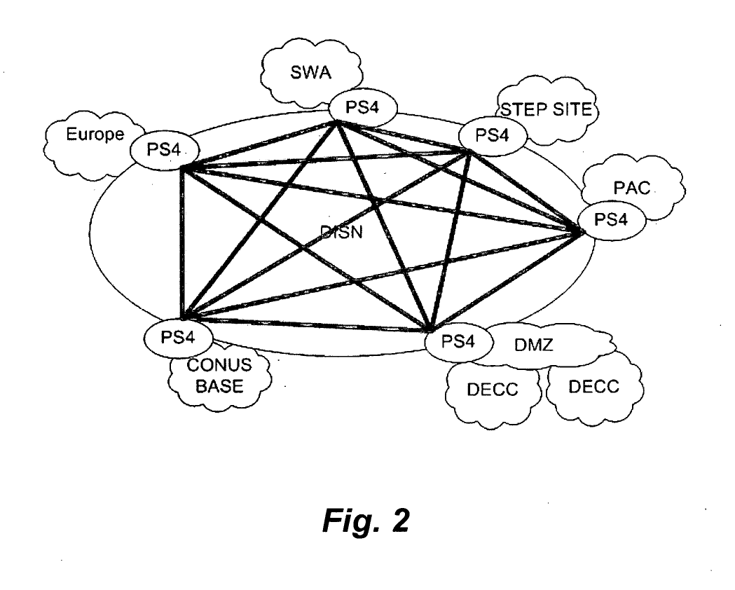

FIG. 2 illustrates the distribution of multiple nodes (labeled as PS4) across a WAN. Together, they form a private network (labeled DISN in reference to a Defense Information System Network, one type of private secure network) accessible securely from locations distributed across an underlying WAN.

The apparatus includes a switch through which at least two of the network components communicate. Optionally, most or all of the network components may communicate through this switch. The switch can filter and forward layer 2 packets within LAN segments, and can provide distinct logical separation between a plurality of internal Virtual LANs (VLANs).

Importantly, through the selection of network components, as well as programming and configuration of this switch (and optionally of the router), each apparatus may be made to comply with various government, military, and/or private security standards or requirements. As a non-limiting example, apparatuses have been prepared which meet the Federal Information Processing Standard (FIPS) no. 140-2 security requirements. The apparatus may be further configured to meet additional requirements for any degree of classified information. In this way, by configuring both the network components and the switch (and/or router) through which they communicate, the node or nodes becomes capable of forming a secure private network compliant with most government, military, or business security demands, including known guidelines for classified or secret information management.

Within the apparatus, 10/100/1000 MB Copper RJ-45 Ethernet connections and devices may join the network components and the switch, although 1000 MB Single and Multi-mode Fiber Ethernet with Small Form-factor Pluggable (SFP) transceivers may also be used. The switch itself may have multiple 10/100/1000 MB Copper RJ-45 Ethernet ports with Power over Ethernet (POE), as well as 1000 MB Single and Multi-Mode Fiber Ethernet with SFP transceiver ports.

Access to the network may be secured at each node in a number of ways, including (as non-limiting examples) through the use of Firewalls, proxies, and Virtual Private Networks (VPNs), as will be described below in detail. Optionally, these network devices may be used to identify any and all system users. As a non-limiting example of user identification for security, each apparatus may be configured with an remote management interface and proper access control list to limit only external users access to the dedicated remote management interface. Before users can connect to any management device via this dedicated remote management interface, they must first connect through a secure VPN or by way of a Customer Service Desk (CSD) external infrastructure. Effectively, such a procedure provides a secure connection to an internal network for management only. If the CSD infrastructure is for any reason down, the device may as a backup allow VPN access. However, this is only one example of access security, and others may be used.

The apparatus may optionally include one or more storage devices for the storage of (as non-limiting examples) the access control list given above, other account and password information, and instructions for proper communication between the network components.

The apparatus may be remotely and securely tunable and configurable to correct problems and to meet individual needs.

A number of the network components which may be used with the present apparatus will now be discussed.

Firewall

One of the network components may be a Firewall.

The Firewall may execute electronic instructions for providing protection for internal assets from external entities on one or more of layers 3-7. The Firewall may also or alternatively execute electronic instructions for enabling secure connections for external management of the other network components.

The Firewall may play an important role in the security architecture of the apparatus, serving as the main access-control device for anything connecting to the apparatus and the network behind it. To this end, the Firewall may provide tunnels, such as secure socket layer (SSL) VPN tunnels, which allow secure connections for Customer Service Desk (CSD) management infrastructure nodes for management purposes. The Firewall may optionally access Firewall-specific Access Control Lists (ACLs), created before any user is permitted resource access on the network protected by the Firewall. These rules may reside on the Firewall. As non-limiting examples, Layer 3, Layer 4, and Layer 7 rules may be used. Once created, such ACLs may secure the system to allow only authorized users to access resources within the network. Depending on the specific service and control needs provided by an operator, different rules of control may be defined for each network device at an apparatus.

The Firewall may importantly be used to inspect network traffic and prevent unauthorized access to the customer private network. Firewalls may optionally be installed in accordance with security instruction, such as the DISA Enclave Security Instruction which requires Firewalls to be installed in the most restrictive mode (i.e., deny all unless explicitly permitted). The Firewalls may be configured for remote management from a central location, as detailed above.

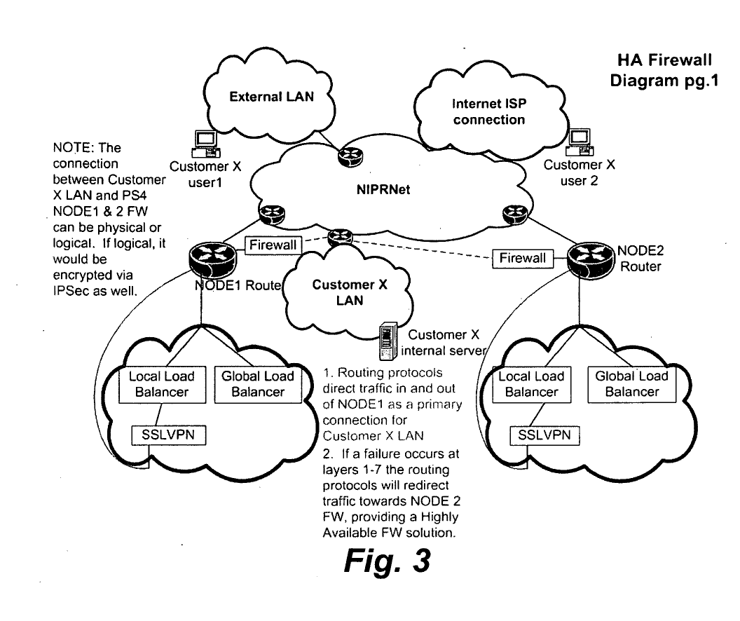

FIG. 3 illustrates data flow through the Firewall, and shows how users may access customer applications through a connection between the WAN and the customer's private network. This connection occurs at the presently claimed apparatus. The connection between the private network and the Firewall may be physical or logical, and if logical, may be encrypted. Importantly, if a failure occurs at any layer, routing protocols, which normally direct traffic through a given node, can redirect traffic toward another node on the network, and through its Firewall.

This is merely one example of a Firewall which may be used according to the present disclosure. Other types of Firewalls and Firewall schemes may also be used to provide one or more levels of security including packet filtering, circuit-level gateway, and application gateway. These other types of Firewalls include, but are not limited to packet filtering Firewalls, circuit-level gateway Firewalls, application-level gateway Firewalls, and stateful inspection Firewalls; each may be a part of the above Firewall procedure or a separate Firewall procedure.

Packet filtering Firewalls inspect the header of each incoming and outgoing packet for user-defined content, such as an IP address or a specific bit pattern, but do not validate or track the state of sessions. These Firewalls typically also filter at the application port level—for example, file transfer protocol (FTP) access generally utilizes port 21. Generally any packet with the right IP address can pass through the filter once the port is enabled

Circuit-level gateway Firewalls validate TCP and, in some products, User Datagram Protocol (UDP) sessions before opening a connection or circuit through the Firewall. The state of the session is monitored, and traffic is only allowed while the session is still open. It should be noted that if a gateway does not support UDP, it cannot support native UDP traffic such as DNS and Simple Network Management Protocol (SNMP).

Application-level gateway Firewalls run an application process on the Firewall for each application that is supported. By understanding the application and the content of the traffic flowing through the Firewall, typically a high degree of control can be applied. For example, a given user can have the right to use a certain application, such as FTP, but only for some commands (such as “get”) and not for others (such as “put”). In addition, application traffic, down to the level of specific file types, can be controlled, for example by allowing “.doc” files to be transferred through the gateway, but not “.xls” files. These Firewalls typically also provide highly detailed logging of traffic and security events. In addition, application-level gateway Firewalls can use Network Address Translation to mask the real IP address on a node on the internal network and thus make it invisible to the outside

Stateful inspection Firewalls are essentially hybrid Firewalls that have elements of one or more of the above Firewalls, but lack the full application layer inspection capabilities of an application level gateway. An example of such a Firewall is a traffic inspection engine is based on a generalized scripting language. The engine executes inspection rules written in this language.

These are merely some examples of Firewalls, and other types of Firewalls may also be used.

Network Attached Storage Device

One of the network components may be a Network Attached Storage (NAS) device. The device in some aspects is a physical storage device (such as a magnetic storage device) housed at the node. The NAS device moves certain file structures closer to the user, and enables users to consolidate servers or data centers and to retire point edge storage solutions without disrupting support of the user base. It allows the customer to place highly available, local storage at the edge of the network, close to users without having to place the server or data center resources there as well. The NAS device may also provide a local data backup solution for remote users and a means of disaster recovery for all users, without compromising the security of any private network or VPN.

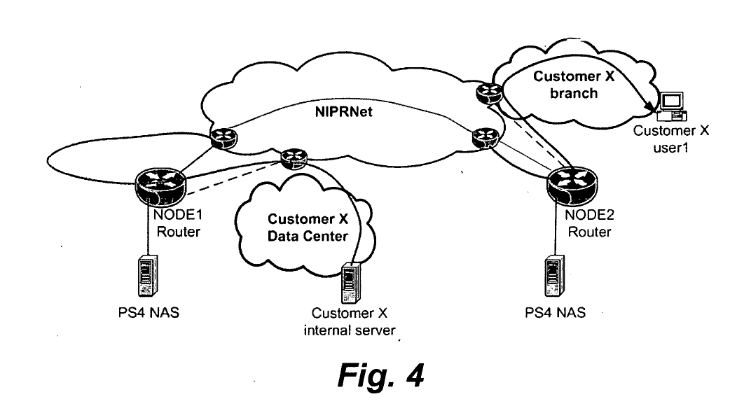

FIG. 4 illustrates how encryption security for ports and protocols for communication with the NAS device may be handled using IP Security protocols or Secure Socket Layer Virtual Private Network (SSL VPN) protocols.

On-Demand Ad Hoc Network Service Provider

One of the network components may be an On-Demand Ad Hoc Network service provider.

The On-Demand Ad Hoc Network service provider may execute electronic instructions for dynamically adding users to a network, and for enabling said users to securely access applications internal to the network. The On-Demand Ad Hoc Network service provider may be used to enable quick standup of secure geographically independent COI networks. These networks can, as non-limiting examples, allow for secure cross-service, cross-agency, cross-department, and cross-coalition collaboration.

The On-Demand Ad Hoc Network service provider may be configured to allow a customer to securely add users to the network dynamically, and to provide them with secure access to internal applications without the need to distribute software to them. As a non-limiting example, the On-Demand Ad Hoc Network service provider may comprise a SSL VPN Appliance that terminates client VPN tunnels, providing external users with a secure encrypted methodology to connect to sensitive assets.

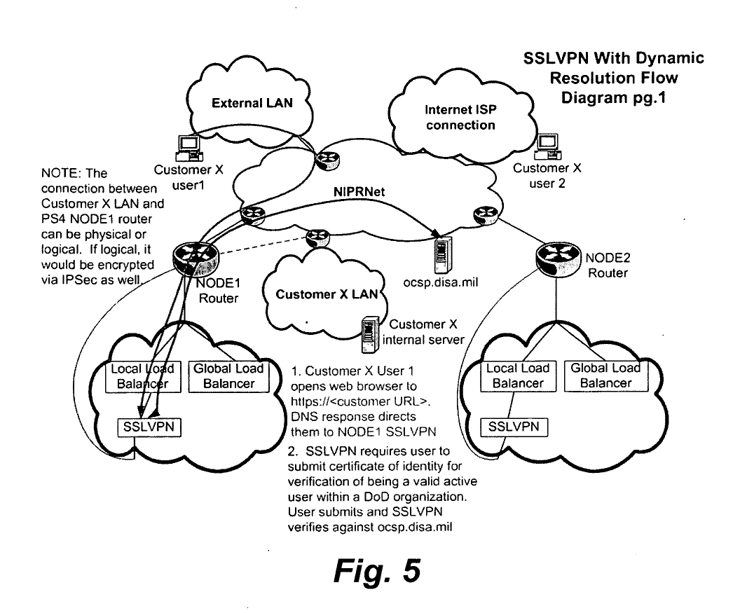

FIGS. 5-10 illustrate one process for forming data flows for an On-Demand Ad Hoc Network service.

In FIG. 5, a user opens a web browser, and requests a secure Universal Resource Locator (URL). A dynamic name service response directs the user to an SSL VPN managed by a first node. This SSL VPN requires the user to submit a certificate of identity for verification of being an active user within an organization. This certificate may be verified against an external list.

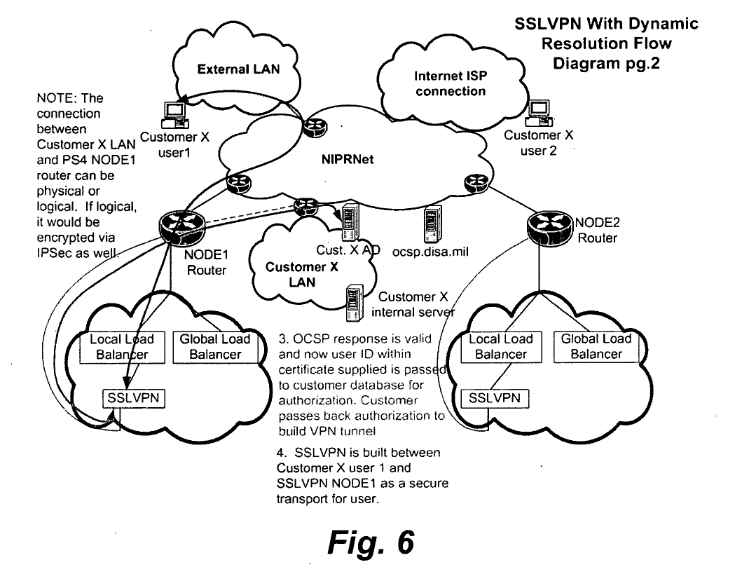

Next, in FIG. 6, assuming a valid response is received from the external list manager, a user ID within the certificate is passed to a customer database for authorization. The authorization is returned by the user, and a VPN tunnel is formed. Thus, a SSL VPN is now built between the user and the node.

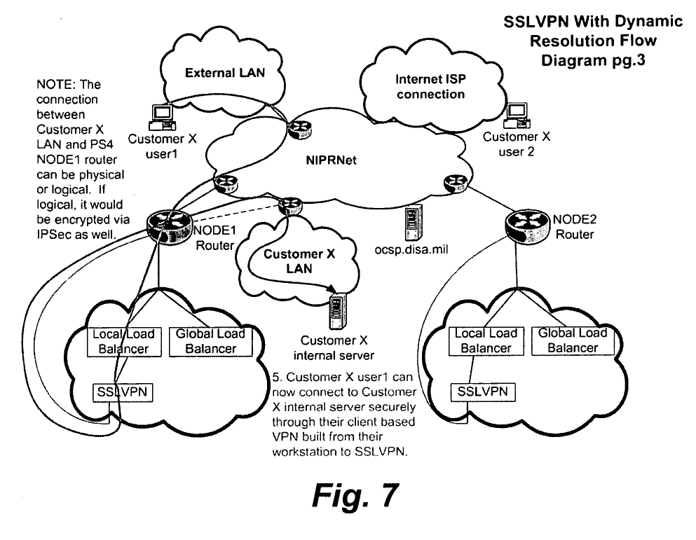

Next, in FIG. 7, the user begins connecting to an internal server on the private network protected by the node, through the client-based VPN.

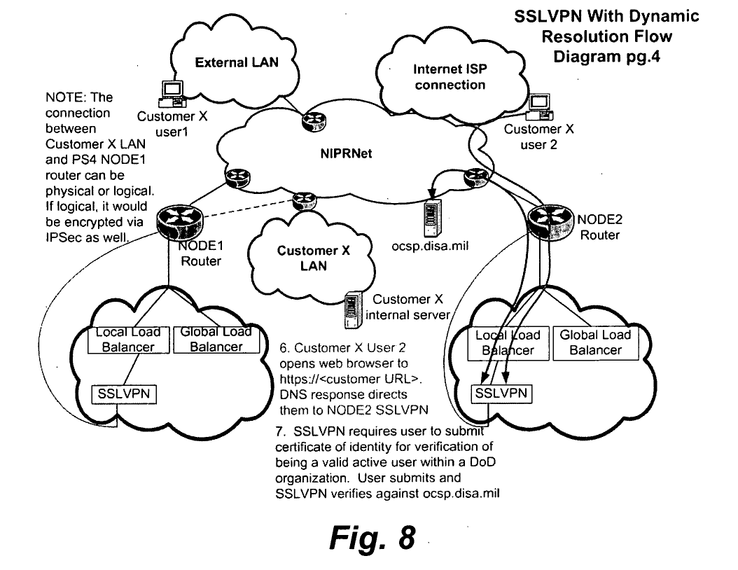

In FIG. 8, a second user opens a web browser, and requests a secure URL. A dynamic name service response directs the user to an SSL VPN managed by a second node, based for example on the user's location, or any other factor. This SSL VPN requires the user to submit a certificate of identity for verification of being an active user within an organization. This certificate may again be verified against an external list.

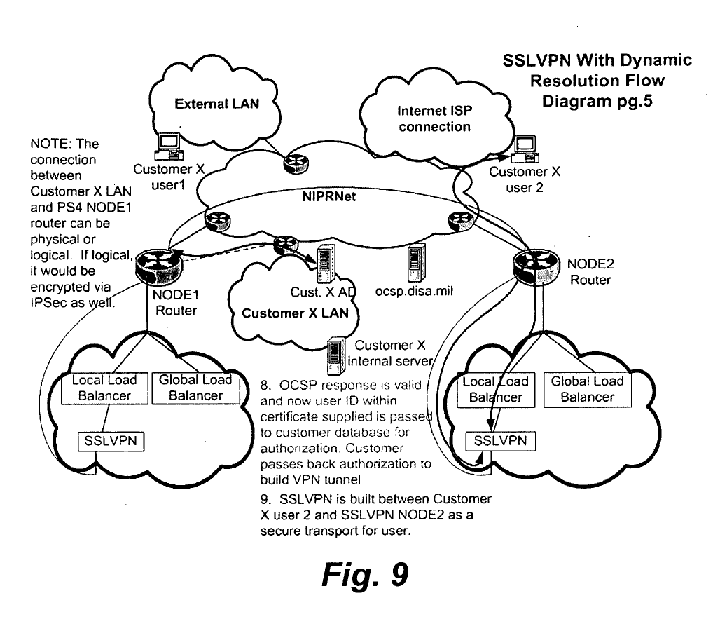

Next, in FIG. 9, assuming a valid response is received from the external list manager, a user ID within the certificate is passed to a customer database for authorization. The authorization is returned by the user, and a VPN tunnel is formed. Thus, a SSL VPN is now built between the user and this second node.

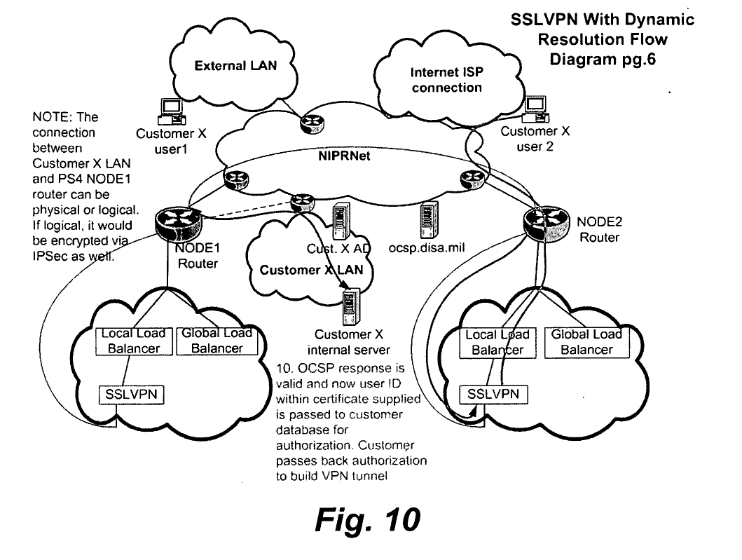

Finally, in FIG. 10, the user begins connecting to an internal server on the private network protected by the second node, through the client-based VPN.

This is merely one example of a process for providing an On-Demand Ad Hoc Network service, and others may be used.

Local and Global Load Balancers

One of the network components may be a Local Load Balancer, and at least one node may also or alternatively include a Global Load Balancer.

In some optional aspects, the apparatus is part of a network of like apparatuses. In these situations, the Global Load Balancer may allow multiple instances of any service to appear to the networked user as if it were on distributed service. The Global Load Balancer may pick up content from multiple origin services and present it as one, and may draw a user to the closest geographic node to provide the service. Thus, the Global Load Balancer may work in conjunction with one or more Local Load Balancers at other nodes throughout the system, executing electronic instructions for using DNS to dynamically route a user to content stored at one of the apparatuses from among the apparatuses which is closest to the user. Those nodes having Global Load Balancers may be geographically distributed across the network.

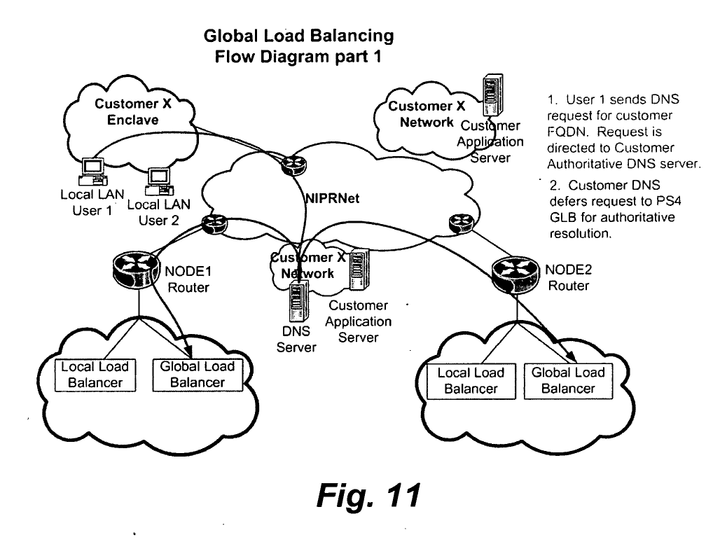

FIGS. 11-16 illustrate a non-limiting example of successive steps for Global Load Balancing by two apparatuses disposed at multiple locations on a network, according to the present disclosure. It should be emphasized that this is merely one example of load balancing, and other forms may be used within the present disclosure.

In FIG. 11, a first user sends a DNS request for a fully qualified domain name (FQDN). The request is routed to an authoritative DNS server for the customer's private network. This request is rerouted by the DNS server to both a first node's Global Load Balancer and a second node's Global Load Balancer for authoritative resolution.

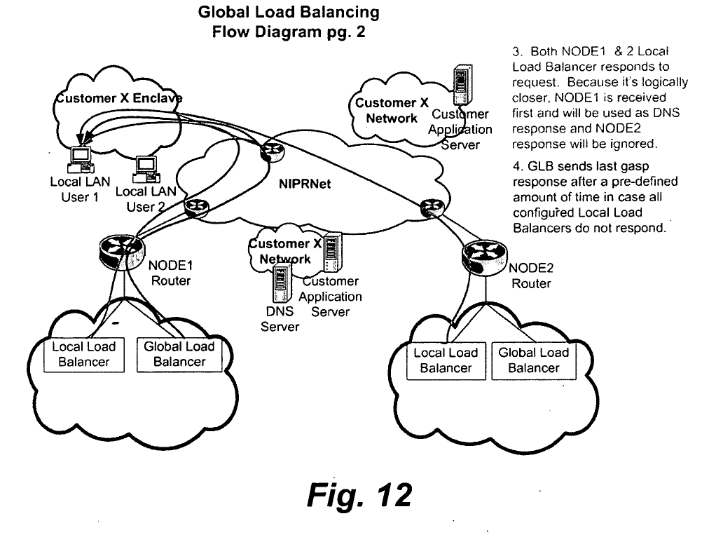

In FIG. 12, both the first and second nodes respond to the request, but the message from logically-closer first node is received first. Accordingly, the first node response is used as the authoritative DNS response, and the second node response (or any other node's response) is ignored. The Global Load Balancer optionally sends a last response after a predetermined amount of time, in case all of the configured local load balancers at all other nodes have not responded.

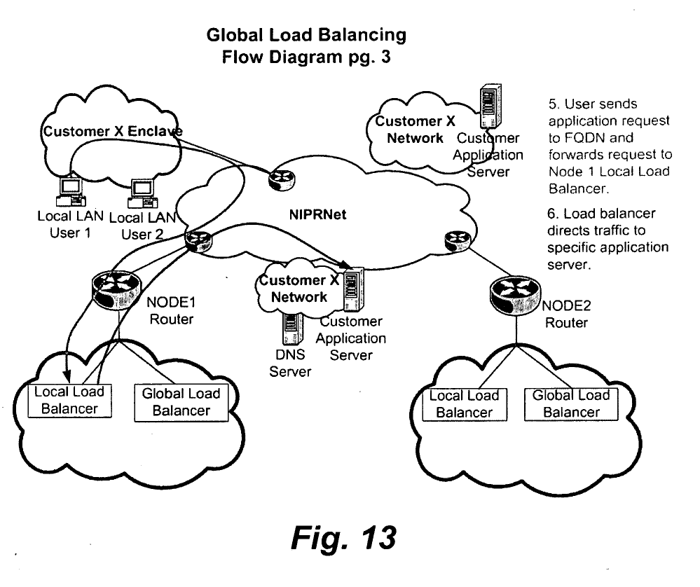

In FIG. 13, the user then sends an application request to a fully qualified domain name, which is forwarded to the Local Load Balancer of the first node. This Local Load Balancer thus directs the traffic to a specific application server within the private network, as chosen by the above load balancing operation.

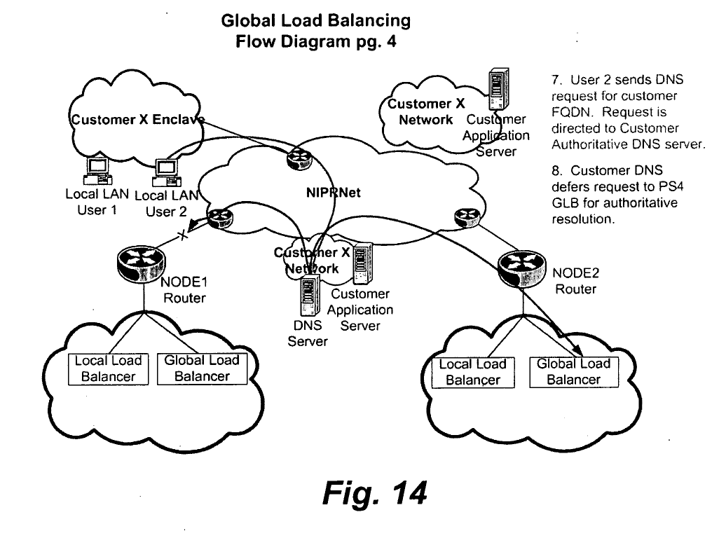

In FIG. 14, a second user sends a new DNS request for a fully qualified domain name. The request is routed to an authoritative DNS server for the customer's private network. This request is rerouted by the DNS server to a second node's Global Load Balancer for authoritative resolution. However, unlike in FIG. 10, this request never reaches the first node's Global Load Balancer, which has already been placed in use for the first user.

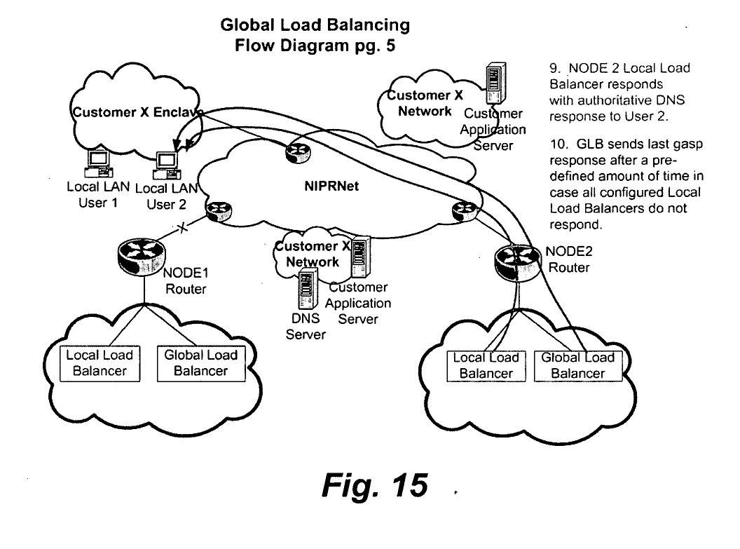

Accordingly, in FIG. 15, only the second node responds to the request, and thus the second node response is used as the authoritative DNS response. The Global Load Balancer optionally sends a last response after a predetermined amount of time, in case all of the configured local load balancers at all other nodes have not responded.

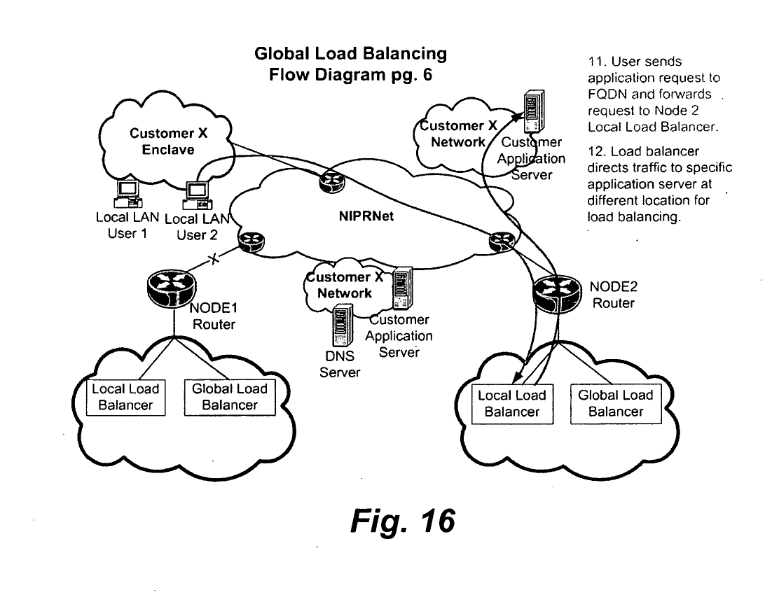

Finally, in FIG. 16, the user then sends an application request to a fully qualified domain name, which is forwarded to the Local Load Balancer of the second node. This Local Load Balancer thus directs the traffic to a specific application server within the private network, as chosen by the above load balancing operation.

This is merely one example of a process for providing a load balancing service, and others may be used. As non-limiting examples, each node may independently operate a Local Load Balancer, and some nodes may even have multiple Local or Global Load Balancers, as needed.

Multi-Protocol Reverse Proxy

One of the network components may be a Multi-Protocol Reverse Proxy. The reverse proxy brings information closer to users by managing information requests and forwarding these requests to other servers in an efficient manner. Optionally, the reverse proxy includes multi-protocol caching, enabling better response times and using less bandwidth than traditional proxy services. The proxy may reduce access time to network content, and importantly may prevent direct external access under one or more protocols.

The protocols may be File Transfer Protocol (FTP), Lightweight Directory Access Protocol (LDAP), and Secure Shell (SSH). Other protocols may also or alternatively be proxied.

Non-limiting examples of data formats and types which may be proxied include video files, presentations, and large documents.

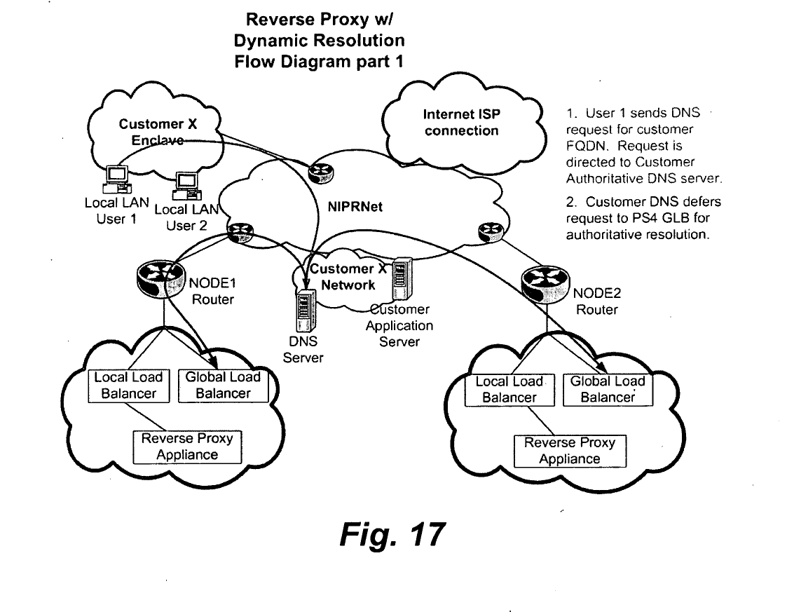

FIGS. 17-22 diagram a sequence of reverse proxying with dynamic resolution by two apparatuses disposed at multiple locations on a network, according to the present disclosure.

In FIG. 17, a first user sends a DNS request for a fully qualified domain name. The request is routed to an authoritative DNS server for the customer's private network. This request is rerouted by the DNS server to both a first node's Global Load Balancer and a second node's Global Load Balancer for authoritative resolution.

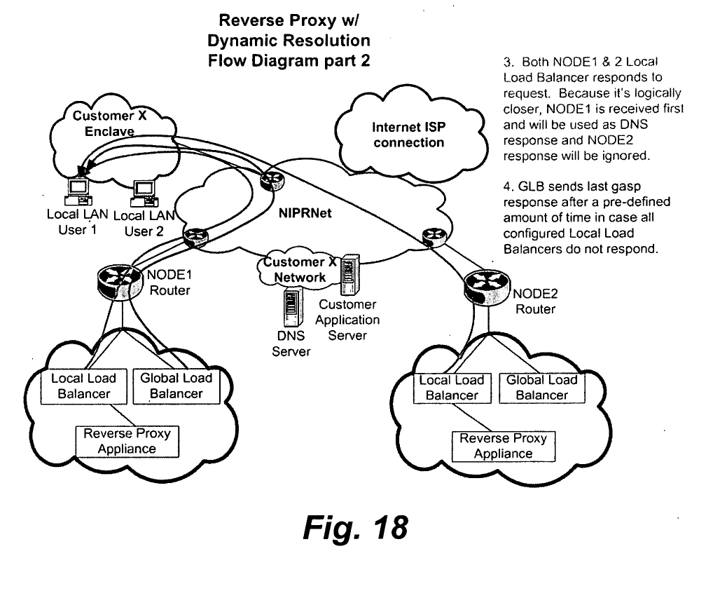

In FIG. 18, local load balancers at both the first and second nodes respond to the request, but the message from logically-closer first node is received first. Accordingly, the first node response is used as the authoritative DNS response, and the second node response (or any other node's response) is ignored. The Global Load Balancer optionally sends a last response after a predetermined amount of time, in case all of the configured local load balancers at all other nodes have not responded.

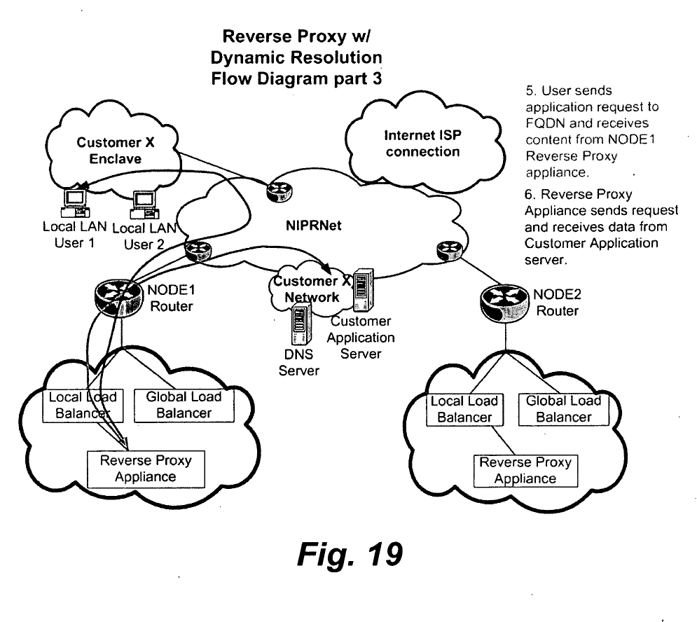

In FIG. 19, the user then sends an application request to a fully qualified domain name, and receives a response from the Reverse Proxy appliance of the first node. This Reverse Proxy appliance thus sends requests and receives data from an application server within the private network, as chosen by the above proxy.

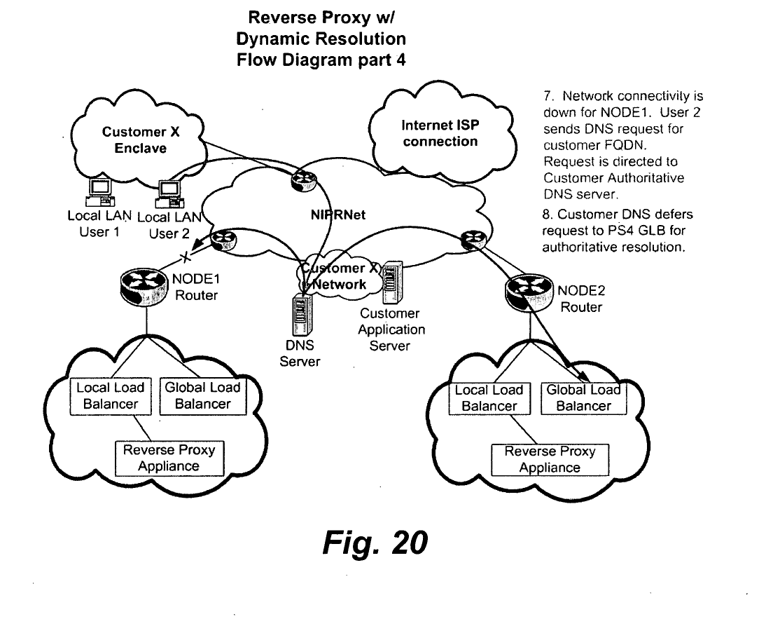

In FIG. 20, network connectivity is down for the first node, so when a second user sends a new DNS request for a fully qualified domain name, the request is routed to an authoritative DNS server for the customer's private network, and deferred to a second node's Global Load Balancer for authoritative resolution.

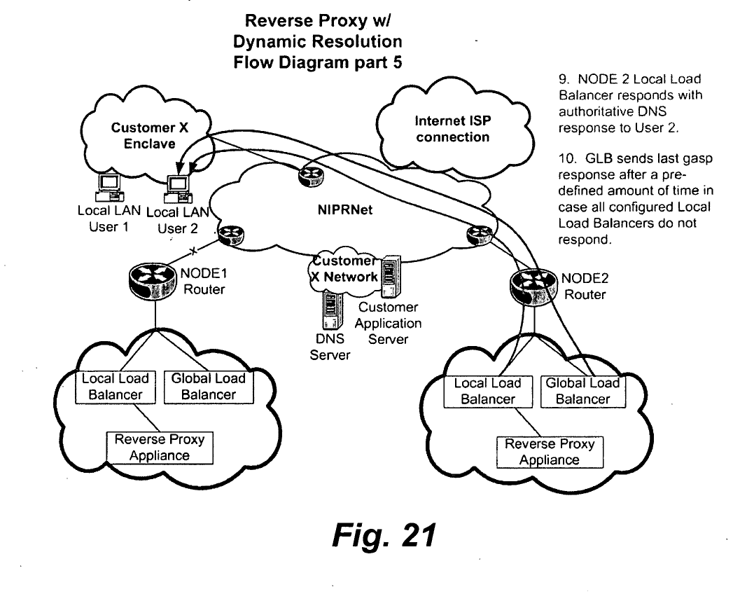

Then, in FIG. 21, the second node responds to the request, and thus the second node response is used as the authoritative DNS response. The Global Load Balancer optionally sends a last response after a predetermined amount of time, in case all of the configured local load balancers at all other nodes have not responded.

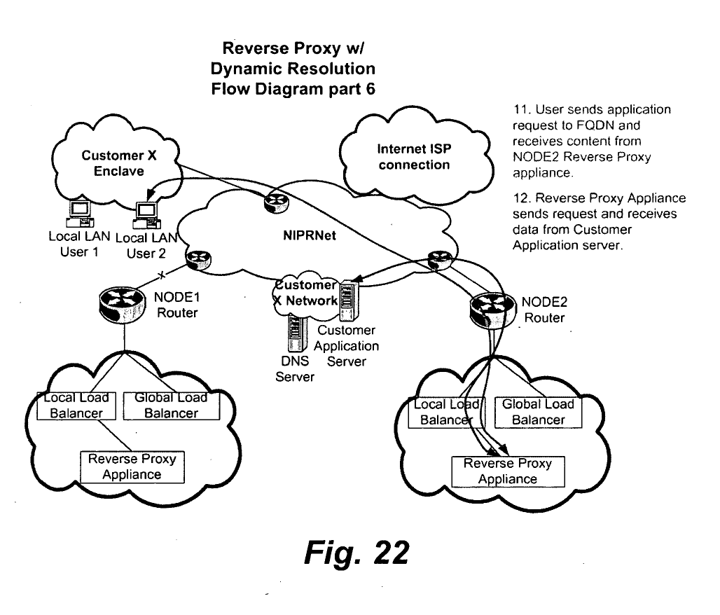

Finally, in FIG. 22, the user then sends an application request to a fully qualified domain name, which is forwarded to the Reverse Proxy appliance of the second node. This Reverse Proxy appliance thus directs the traffic to a specific application server within the private network, as chosen by the above proxying operation.

This is merely one form of proxy, and other forms known in the art may be used.

This proxy may be disposed together with, or work together with, another proxy or a Firewall at the node or at other nodes across the network.

Forward Proxy

One of the network components may be a Forward Proxy. The forward proxy reduces response times for commonly accessed Web sites and information, and provides significant bandwidth reduction for wide area links that are otherwise congested and might otherwise require a costly upgrade. The forward proxy may prevent direct output under one or more protocols. The proxy may include, or alternatively communicate with, a cache or a gateway.

The protocols may be HyperText Transfer Protocol (HTTP), HyperText Transfer Protocol Secure (HTTPS), File Transfer Protocol (FTP), Lightweight Directory Access Protocol (LDAP), and Secure Shell (SSH). Other protocols may also or alternatively be proxied.

Non-limiting examples of data formats and types which may be proxied include video files, presentations, and large documents.

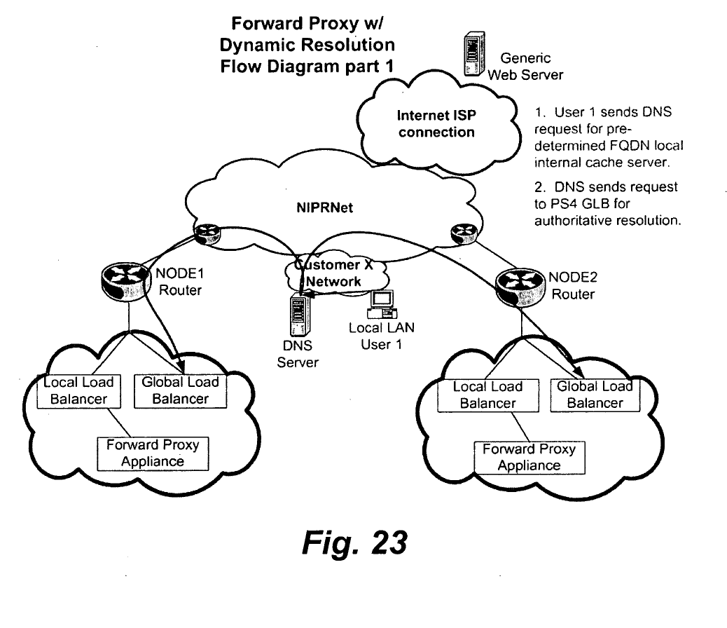

FIGS. 23-32 diagram a sequence of forward proxying with dynamic resolution by two apparatuses disposed at multiple locations on a network, according to the present disclosure.

In FIG. 23, a first user sends a DNS request for a fully qualified domain name. The request is routed to an authoritative DNS server for the customer's private network. This request is rerouted by the DNS server to both a first node's Global Load Balancer and a second node's Global Load Balancer for authoritative resolution.

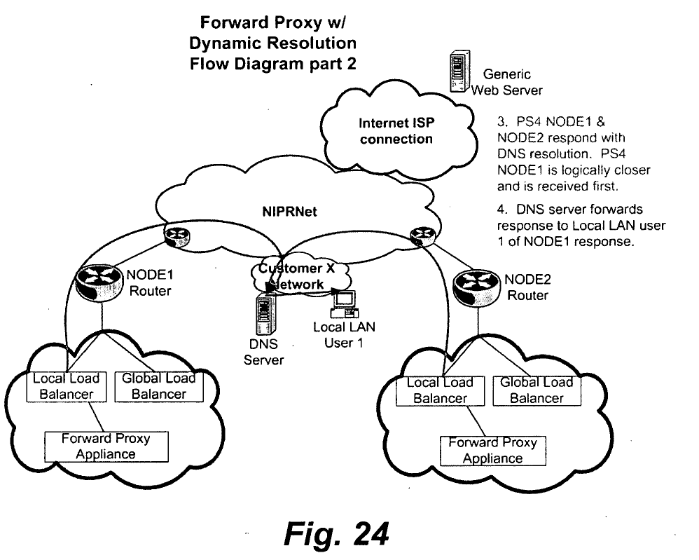

In FIG. 24, both the first and second nodes respond to the request, but the message from logically-closer first node is received first. Accordingly, the first node response is used as the authoritative DNS response, and the second node response (or any other node's response) is ignored.

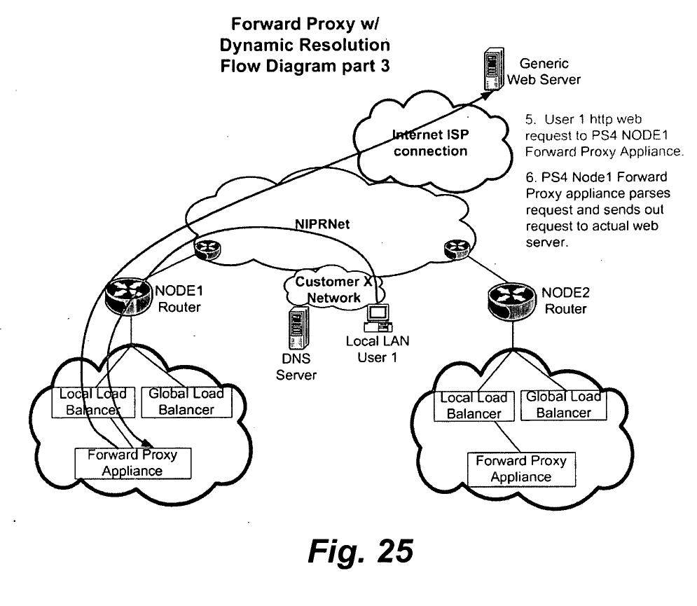

In FIG. 25, the user then sends a web-type request, which is routed to the Forward Proxy appliance of the first node. This Forward Proxy appliance thus parses the request and routes the request to an actual, external web server. Although a web server is shown here, the present method could be applied to any address-based request from any server, with any protocol.

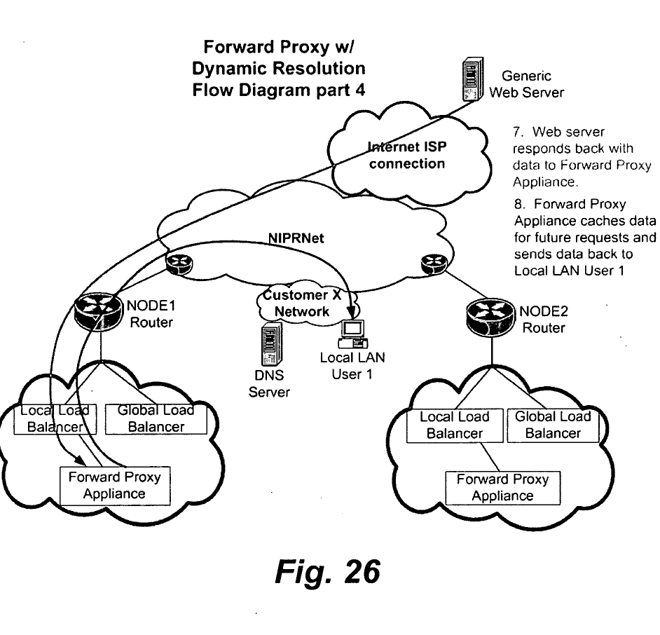

In FIG. 26, the web server responds back with data to the Forward Proxy appliance. The Forward Proxy appliance caches the data for future requests, and then sends the data back to the user.

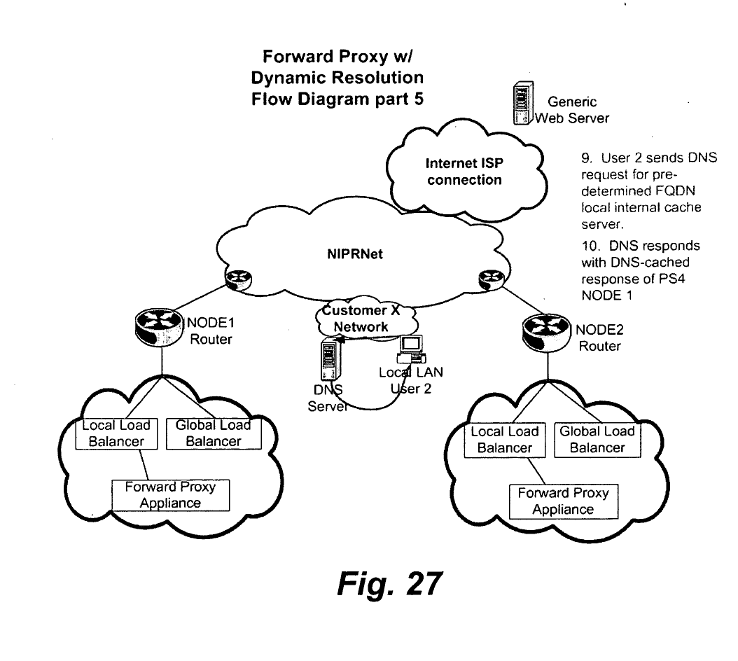

In FIG. 27, a second user sends a new DNS request for a fully qualified domain name. The request is routed to an authoritative DNS server for the customer's private network. This request is responded to by the DNS server with the DNS-cached response of the first node.

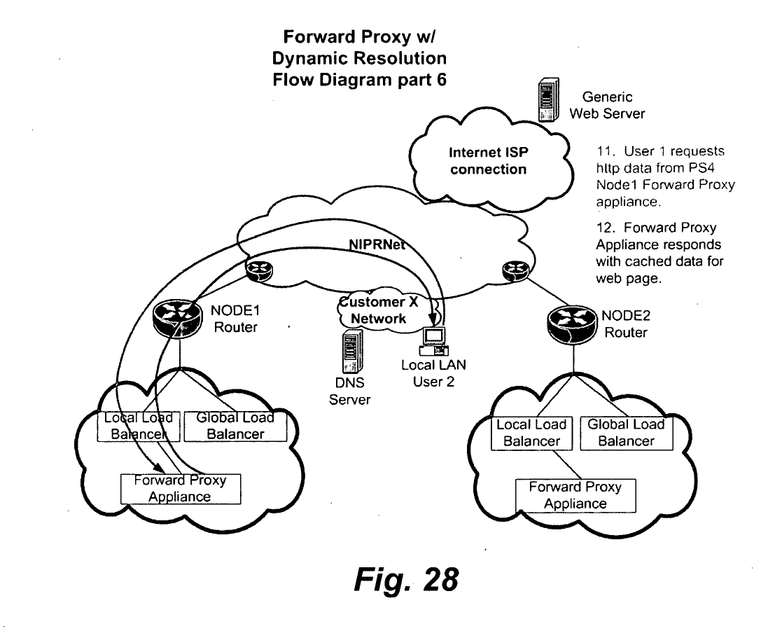

Next, in FIG. 28, the second user then sends an application request to the Forward Proxy appliance, as instructed by the DNS server. The Forward Proxy appliance thus responds with the previously-cached web data.

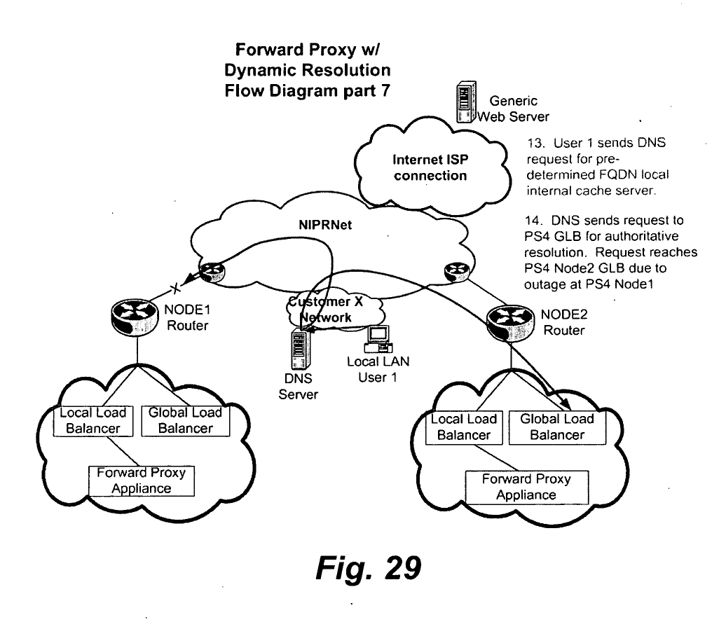

In FIG. 29, the first user again sends a request for a fully qualified domain name from the local Domain Name Server. This request is again rerouted by the DNS server to both a first node's Global Load Balancer and a second node's Global Load Balancer for authoritative resolution, but in this scenario, the request only reaches the load balancer of the second node, because of an outage at the first node of unknown origin.

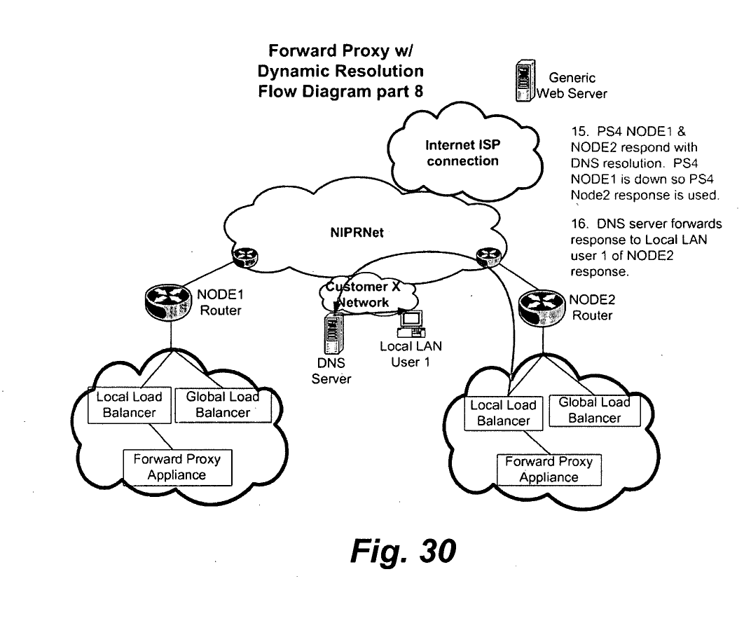

Accordingly, in FIG. 30, only the second node's response is received, and forwarded by the DNS server to the user.

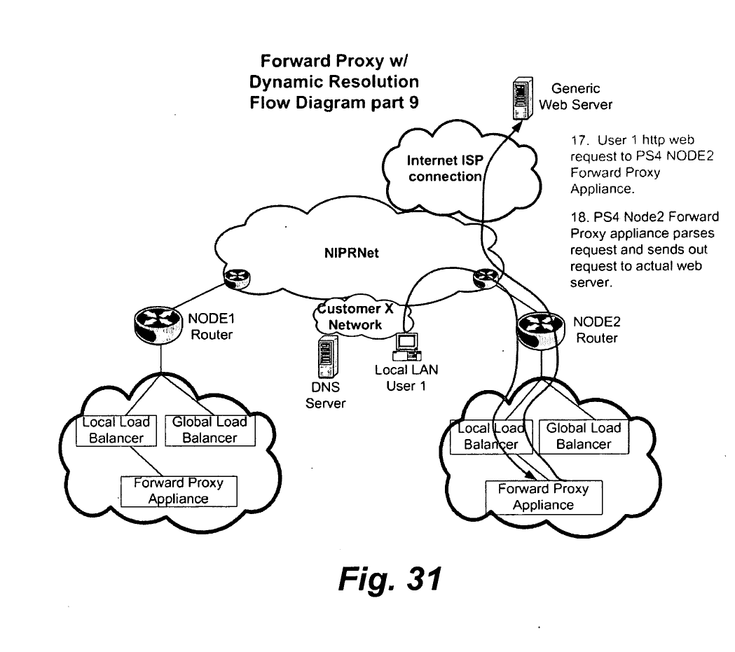

Then, in FIG. 31, the user sends a web-type request, which, based on the previous DNS response, is routed to the Forward Proxy apparatus of the second node. This Forward Proxy appliance thus parses the request and routes the request to an actual, external web server. Although a web server is shown here, the present method could be applied to any address-based request to or from any server, with any protocol.

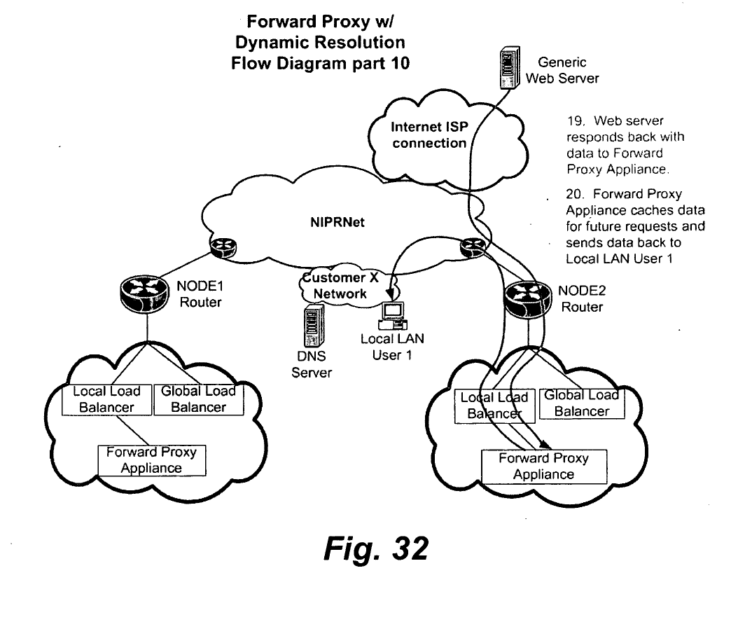

Finally, in FIG. 32, the web server responds back with data to the Forward Proxy appliance. The Forward Proxy appliance caches the data for future requests, and then sends the data back to the user.

This is merely one form of proxy, and other forms known in the art may be used.

This proxy may be disposed together with, or work together with, another proxy or a Firewall at the same node or at other nodes across the network.

Network Optimizer Appliance

One of the network components may be a Network Optimizer Appliance. The Network Optimizer Appliance may be used to increase performance for remote users who are experiencing (as non-limiting examples) poor network performance, such as repeated transmissions, inaccessible data during file transfers, slow patch distribution, slow server connections, slow search query results, and slow file downloads.

As a non-limiting example, the Network Optimizer Appliance at a first node may comprise a TCP Optimizer that improves TCP flow with a second node, for improving network infrastructure. The TCP optimizer can exchange signals or flags between another TCP optimizer, optionally as envelopes to packets, to make packet transfer between the optimizers more efficient.

The following are non-limiting examples of methods by which a Network Optimizer Appliance can accelerate traffic flows: compression, byte caching, object caching, bandwidth management.

As non-limiting examples of advantages conferred by the use of a TCP optimizer, the TCP Optimizer can set the stage for migration to server-less branch/node with optimized applications residing in data centers. It may improve response times of time sensitive applications over the WAN and negate the need for bandwidth upgrades.

The TCP Optimization service may be used in a point-to-point or point-to-multipoint fashion and it can optimize any TCP application flow. Similar Optimizers may be installed for other protocols as needed. Application-specific acceleration of Network Attached Storage servers may also be provided by the Network Optimizer Appliance.

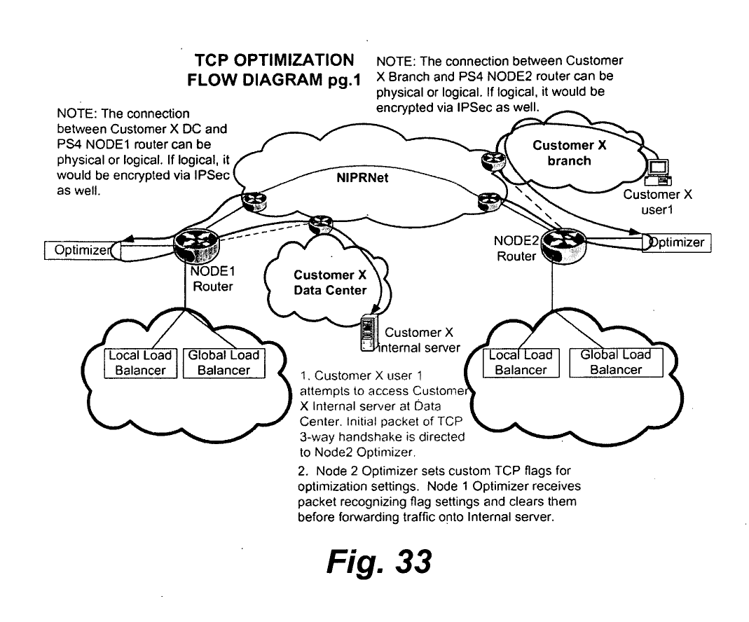

FIGS. 33-38 illustrate one form of optimized data flow utilizing Network Optimizer Appliances according to the present disclosure. This is merely one example, and other forms of Optimization may be used. Further, redundancy (not shown) may be used to support higher availability.

In FIG. 33, a first user attempts to access an internal server at a remote data center. The initial packets of this access step are directed to a Network Optimizer Appliance at a node near to the user, here the “second node.” The second node's Network Optimizer Appliance then sets custom TCP flags for optimization settings, and then forwards the TCP packet to a Network Optimizer Appliance at a node distant from the user, here the “first node.” The first node's Network Optimizer Appliance receives the packets, recognizes the flag settings, and clears them before forwarding the traffic to the internal server.

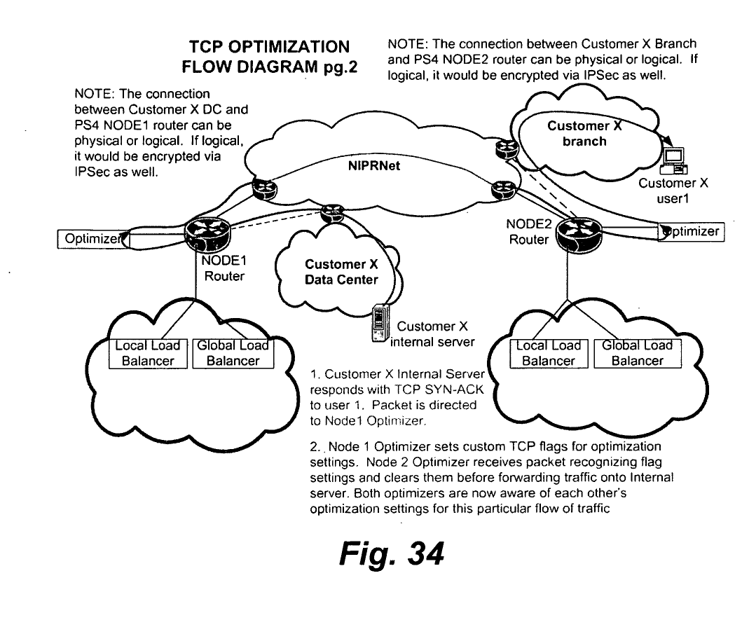

In FIG. 34, the internal server responds with a TCP acknowledgement and synchronization (SYN-ACK) directed to the first user. Packets are directed back to the Network Optimizer Appliance of the first node. The first node's Network Optimizer Appliance then sets custom TCP flags for optimization settings, and sends the packets to the second node's Network Optimizer Appliance, which receives the packets, recognizes the flags settings, and clears them before forwarding traffic on to the first user. At this point, both the first node's Network Optimizer Appliance and the second node's Network Optimizer Appliance are aware of each other's optimization settings for this particular flow of traffic.

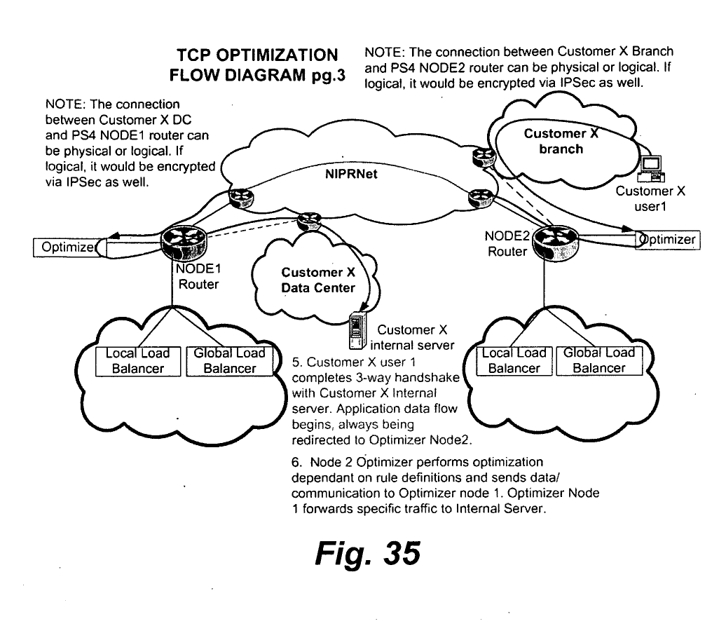

Next, in FIG. 35, the first user again attempts to access the internal server. As before, the initial packets of this access step are directed to the Network Optimizer Appliance at the node near to the user, the “second node.” The second node's Network Optimizer Appliance, now aware of the first node's Network Optimizer Appliance rules, performs optimization dependent on the rule definitions, and sends the optimized data transmission to the Network Optimizer Appliance at the first node. The first node's Network Optimizer Appliance receives the packets, and forwards the traffic to the internal server.

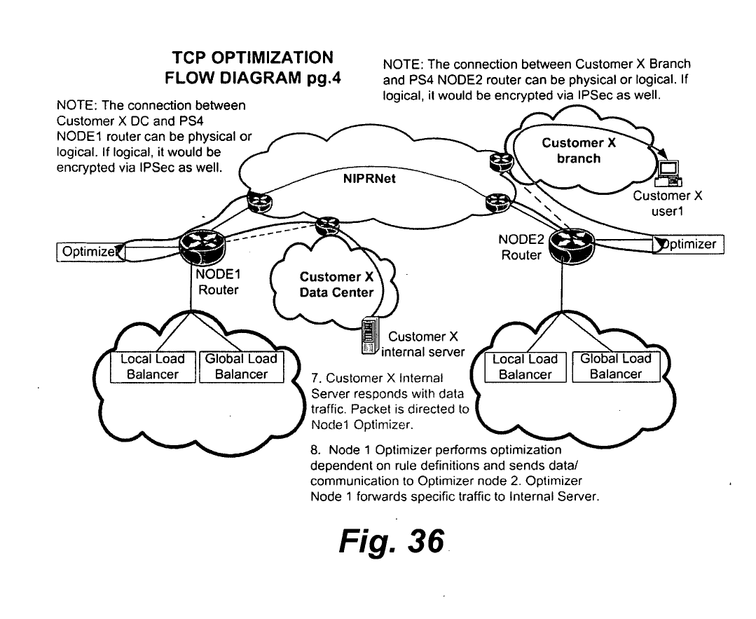

Similarly, in FIG. 36, the internal server responds with data traffic directed to the Network Optimizer Appliance of the first node, which, aware of the second node's Network Optimizer Appliance rules, performs optimization dependent on the rule definitions and sends the optimized data to the Network Optimizer Appliance at the second node, which itself receives the packets, and forwards the traffic to the user.

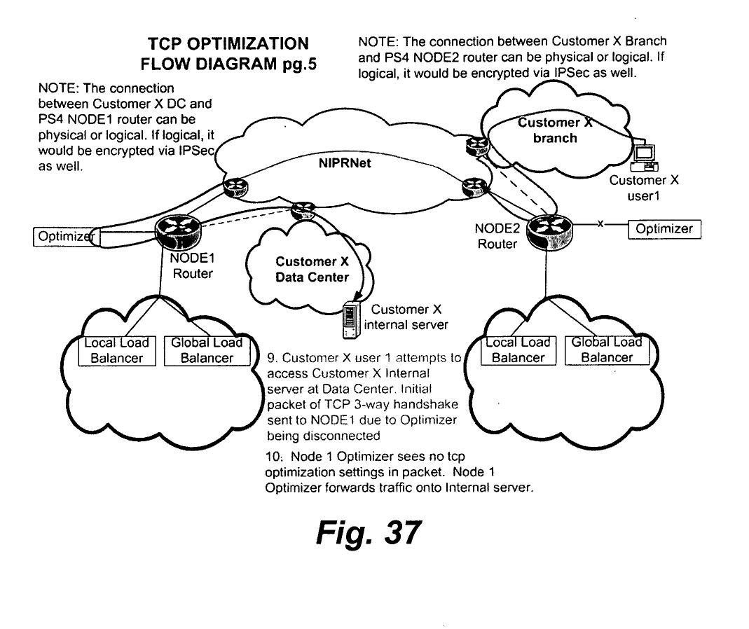

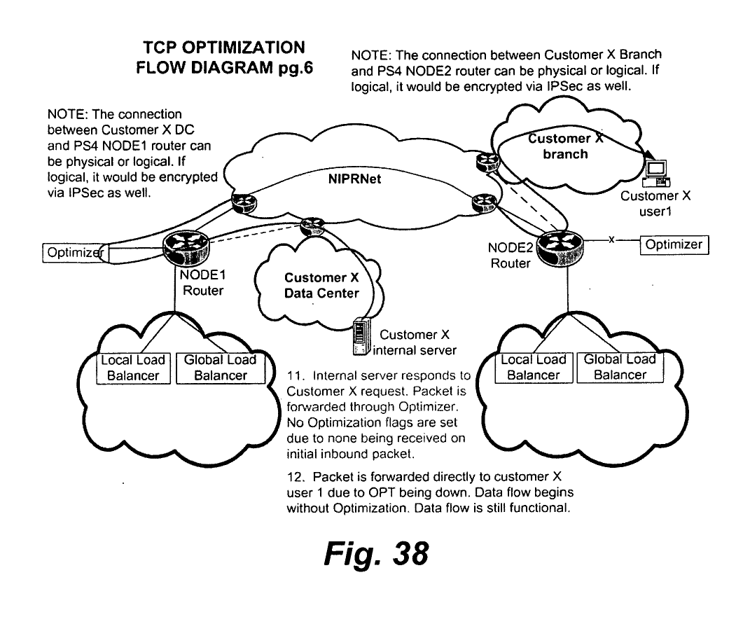

FIGS. 37 and 38 illustrate how the Network Optimizer Appliance of the first node can handle traffic when for any reason the Network Optimizer Appliance of the second node is disconnected or absent.

In FIG. 37, a user sends initial packets, which would normally be directed to the Network Optimizer Appliance at the node near to the user, the “second node.” Here, however, since the second node's Network Optimizer Appliance is disconnected, the second node routes the handshake and packets directly to the first node, without optimization settings in packet. The Network Optimizer Appliance of the first node thus forwards the packets directly to the internal server.

Thus, in FIG. 38, when packets from the internal server are forwarded through the first node, the first node's Network Optimizer Appliance knows not to add any optimization flags, since no flags were received in the initial transmission from the second node. Thus, the packets are forwarded directly to the user, and data flow is still functional, although not optimized.

This is merely one example of Network Optimization, and others may be used. As non-limiting examples, Network Optimization may be performed over other protocols, including gateway protocols, and may be turned for particular environments (e.g. transatlantic communication or communication with a portable media device).

Domain Name Service Server.

One of the network components may be a Domain Name Service (DNS) server. The DNS server may provide recursive DNS, allowing internal hosts to perform outbound lookups. In some optional aspects, the node can only process DNS requests through DNS referrals from authoritative customer DNS servers or direct DNS queries by hosts.

DNS resolution may include, but is not limited to, round robin, least load, weighted, and proximity resolution. Optionally, the DNS server may be proprietary to the apparatus, where the highest security is demanded. By placing the DNS server at the apparatus, direct control may be maintained over multiple network levels.

Secure Socket Layer Virtual Private Network Appliance

One of the network components may be a Secure Socket Layer Virtual Private Network (SSL VPN) Appliance. The appliance may terminate client VPN tunnels to provide a secure encrypted methodology for users to connect to sensitive assets over TCP port 443. As a non-limiting example, this appliance may be used to provide a secure entry for management and maintenance of the network components.

Beyond the above network components, the apparatus may optionally comprise an auditor, which makes an audit log. An optional audit trail mechanism records some or all security-relevant events. The audit trail software and the audit trail log may be protected by the security mechanisms available on each component, and on the switch. The audit trail log may be written to files that may be accessible, configurable, and/or under the control of a security manager or a designated alternate authority. The Security Manager or designated Security Officer may be allowed to examine and review the audit logs periodically to detect and minimize inadvertent modification or destruction of data and to detect and prevent malicious modification or destruction of data. Non-limiting examples of events audited include: Logons and logouts; Excessive logon attempts/failures; Remote system access; Change in privileges or security attributes; Failed attempts to access restricted system or data files; and Audit file access.

When two or more nodes are disposed across a network in a distributed architecture, a single apparatus failure or node failure need not critically affect overall system functionality. A failover apparatus may be clearly defined and configured, such as a similar apparatus at a different node, so it is ready for use should the first apparatus fail. A failover apparatus may be used, as a non-limiting example, when a node experiences maintenance downtime. Further, configuration of each network device within a node may be stored at a Remote Management site, which remains available even if any networking device within the node fails. Although optionally available, a dedicated system data backup network (for disaster recovery) is therefore not necessary. Further, when a distributed architecture of nodes is utilized, there is no maximum downtime limit. Given a sufficient number of nodes, dynamic load balancing across the platform network (as described above) is not expected to impact operational or functional capabilities of the network, and user communications from inside or outside of the private network or COI may be redirected to another node until the local node is returned to production.

Optionally, the apparatus may include a Keyboard Video Mouse Appliance that executes electronic instructions for providing access to network components. This device may be optionally accessible only through the SSL VPN, and can a secure method of having console access to a device through a remote connection. The device may sit inside a network protected via VPN, and may be limited to access through SSL.

Optionally, the apparatus may include a Serial Console Appliance that executes electronic instructions for providing access to network components. This device may be optionally accessible only through the SSL VPN, and can a secure method of having console access to a device through a remote connection. The device may sit inside a network protected via VPN, and may be limited to access through SSL.

Optionally, the apparatus may include a Power over IP Appliance configured to power cycle one or more of the network components upon remote instructions. The Power over IP Appliance may be instructed to power cycle any or all network components or other apparatus components, at once or in a predetermined order, when one or more network components malfunctions or ceases functioning altogether.

In one aspect, a housing may be provided which is configured to physically house one or more network devices like those described above. The housing may include a router that provides the only external connectivity to the apparatus, and a switch that executes electronic instructions for providing a communicative connection among two or more network components. This housing is uniquely configured to provide the security features for inter- and intra-component communication described above.

In some aspects, merely a housing is initially provided, with only a router and a switch, but with the switch and/or router configured in advance to provide secure electronic communication between network components which will later be installed in the housing.

Various components of the apparatus comprise computer processors and electronic instructions. These instructions may be stored in a “machine readable medium,” in hardware, or in a combination of the two.

Making general reference to the methods, systems, and apparatuses described above, those of skill in the art will understand that information and signals may be represented using any of a variety of different technologies and techniques. For example, data, instructions, commands, information, signals, bits, symbols, and chips which may be referenced throughout the above description may be represented by voltages, currents, electromagnetic waves, magnetic fields or particles, optical fields or particles, or any combination thereof.

Those of skill in the art will further appreciate which of the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. “Storage medium” may represent one or more machine readable mediums or devices for storing information. The term “machine readable medium” includes, but is not limited to, wireless channels and various other mediums capable of storing, containing, or carrying instructions and/or data.

The previous description of some aspects is provided to enable any person skilled in the art to make or use the presently disclosed methods and apparatuses. Various modifications to these aspects will be readily apparent to those skilled in the art, and the generic principles defined herein may be applied to other aspects without departing from the spirit or scope of the invention. For example, one or more elements can be rearranged and/or combined, or additional elements may be added. Thus, the present invention is not intended to be limited to the aspects shown herein but is to be accorded the widest scope consistent with the principles and novel features disclosed herein.

What is claimed is:

1. An apparatus for improving network infrastructure, the apparatus comprising:
network components comprising:
a Domain Name Service server,
a Local Load Balancer,
a Firewall, and
one or more routers that provide the only external network connectivity to the apparatus;
the apparatus further comprising:
a Switch;
wherein at least two network components communicate with each other through said Switch.

2. The apparatus of claim 1, the apparatus further comprising:
at least one network component selected from the group consisting of:
a Network Attached Storage device,
a Global Load Balancer,
an On-Demand Ad Hoc Network service provider,
a Multi-Protocol Reverse Proxy,
a Forward Proxy,
a Secure Socket Layer Virtual Private Network Appliance, and
a Network Optimizer Appliance.

3. The apparatus of claim 2,
wherein all of the network components are communicatively connected to said switch.

4. The apparatus of claim 1,
wherein said switch filters and forwards layer 2 packets to provide distinct logical separation for a Virtual Local Area Network.

5. The apparatus of claim 1,
wherein said Firewall executes electronic instructions for providing protection for internal assets from external entities on at least one layer selected from the group consisting of: layer 3, layer 4, layer 5, layer 6, and layer 7.

6. The apparatus of claim 1,
wherein said Firewall executes electronic instructions for enabling secure connections for external management of said network components.

7. The apparatus of claim 1, the apparatus further comprising:
an On-Demand Ad Hoc Network service provider,
wherein said On-Demand Ad Hoc Network service provider executes electronic instructions for dynamically adding users to a network and for enabling said users to securely access applications internal to said network.

8. The apparatus of claim 1,
wherein the apparatus is part of a network comprising a plurality of apparatuses for improving network infrastructure,
wherein at least one of said apparatuses comprises a Global Load Balancer,
wherein said Global Load Balancer works in conjunction with Local Load Balancers at another of said apparatuses and executes electronic instructions for using Domain Name Service to dynamically route a user to content stored at an apparatus from among said apparatuses which is closest to said user.

9. The apparatus of claim 1, the apparatus further comprising:
a Multi-Protocol Reverse Proxy,
wherein said Multi-Protocol Reverse Proxy reduces access time to network content, and
wherein said Multi-Protocol Reverse Proxy prevents direct external access under two or more protocols selected from the list consisting of: File Transfer Protocol (FTP), Lightweight Directory Access Protocol (LDAP), and Secure Shell (SSH).

10. The apparatus of claim 1, the apparatus further comprising:
a Forward Proxy,
wherein said Forward Proxy reduces access time to external hosts, and
wherein said Forward Proxy prevents direct output under one or more protocols selected from the list consisting of: HyperText Transfer Protocol (HTTP), HyperText Transfer Protocol Secure (HTTPS), File Transfer Protocol (FTP), Lightweight Directory Access Protocol (LDAP), and Secure Shell (SSH).

11. The apparatus of claim 1, the apparatus further comprising:
a Network Optimizer Appliance,
wherein the apparatus is part of a network comprising at least one further apparatus for improving network infrastructure, said further apparatus comprising a further Network Optimizer Appliance, and
wherein said Network Optimizer Appliances each comprise a Transmission Control Protocol (TCP) Optimizer that improves TCP flow between apparatuses.

12. The apparatus of claim 1,
wherein the apparatus is part of a network comprising a plurality of said apparatuses for improving network infrastructure,
wherein said one or more routers of each of said apparatuses executes electronic instructions for providing an on-demand community of interest with the other of said apparatuses.

13. The apparatus of claim 1, the apparatus further comprising:
a Keyboard Video Mouse Appliance,
wherein the Keyboard Video Mouse Appliance executes electronic instructions for providing configuration access to at least one of said network components.

14. The apparatus of claim 1, the apparatus further comprising:
a Serial Console Appliance,
wherein the Serial Console Appliance executes electronic instructions for providing configuration access to at least one of said network components.

15. The apparatus of claim 1, the apparatus further comprising:
a Power over IP Appliance,
wherein said Power over IP Appliance is configured to power cycle one or more of said network components upon remote instructions.

16. The apparatus of claim 1, the apparatus comprising:
an auditor for recording an audit log of security-related events.

17. The apparatus of claim 1,
wherein the apparatus is configured to allow said network components to be assembled in any combination according to the needs of a supported application.

18. A method of establishing and maintaining a private network over a wide area network, the method comprising:
using network components to establish a private network;
providing Firewall protection for internal assets of said private network from external entities on at least one layer selected from the group consisting of: layer 3, layer 4, layer 5, layer 6, and layer 7;
enabling a secure connection for external management of said network components; and
receiving a Domain Name Service request from a user of the private network and dynamically routing said user to content corresponding to said request and stored near said user on the private network.

19. The method of claim 18, the method further comprising:
establishing at least one Virtual Local Area Network; and
providing logical separation between said Virtual Local Area Networks and either of said private network or said wide area network by filtering and forwarding layer 2 packets.

20. The method of claim 18, the method further comprising:
preventing direct external access to said private network under two or more protocols selected from the list consisting of: HyperText Transfer Protocol (HTTP), HyperText Transfer Protocol Secure (HTTPS), File Transfer Protocol (FTP), Lightweight Directory Access Protocol (LDAP), and Secure Shell (SSH); and
preventing direct output from said private network under one or more protocols selected from the list consisting of: HyperText Transfer Protocol (HTTP), HyperText Transfer Protocol Secure (HTTPS), File Transfer Protocol (FTP), Lightweight Directory Access Protocol (LDAP), and Secure Shell (SSH).

21. The method of claim 18, the method further comprising:
dynamically adding users to the private network and enabling said users to securely access applications internal to said private network.

22. The method of claim 18,
wherein the method is operable from a single apparatus with communicative connection to said wide area network.

23. The method of claim 18,
wherein the method is operable from a plurality of apparatuses distributed across said wide area network, with communicative connection to said wide area network.

24. An apparatus for improving network infrastructure, the apparatus comprising:
one or more routers that provide the only external connectivity to the apparatus; and
a switch executing electronic instructions sufficient to provide a communicative connection among at least two network components of types selected from the group consisting of: a Firewall, a Network Attached Storage device, an On-Demand Ad Hoc Network service provider, a Local Load Balancer, a Global Load Balancer, a Multi-Protocol Reverse Proxy, a Forward Proxy, a Network Optimizer Appliance, and a Domain Name Service server; and
a housing configured to physically house said at least two network components,
wherein said communicative connection complies with one or more information security protocols.

25. The apparatus of claim 24,
wherein the apparatus is configured to allow said network components to be assembled in any combination according to the needs of a supported application.
